(19) United States
(12) Patent Application Publication
(10) Pub. No.: US 2005/0015767 A1
(43) Pub. Date: Jan. 20, 2005

(54) Operating system configuration tool

(76) Inventors: Brian Nash, Swindon (GB); Timothy Curtis, Tetbury (GB)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/612,827

(22) Filed: Jul. 1, 2003

(51) Int. Cl. G06F 9/46

(52) U.S. Cl. 718/102

(57) ABSTRACT

According to one exemplary embodiment of the present invention, a method for configuring an operating system is provided. The method includes the step of creating a task schedule on a host, the schedule comprising tasks, task start times, and task deadlines. The task schedule is used to configure a time deadline based operating system on a target computer according to the task schedule. The target operating system is run, while simultaneously capturing event data. The event data is converted into a corresponding graphical representation indicative of the occurrence of significant events on the target, the significant events corresponding to the task start times and the deadlines. The method includes the further step of changing the task start times and task deadlines in response to user interaction with reference to the graphical representation, the changes corresponding to specific significant events; and using the changes to adjust and recreate the task schedule.

### CROSS-REFERENCE TO RELATED APPLICATIONS

This application is related to U.S. Pat. No. 5,872,909 entitled “Logic Analyzer for Software,” the entire disclosure of which is hereby expressly incorporated by reference and co-pending U.S. application Ser. No. ______ [DDK ATTORNEY DOCKET NO. 218.1042], entitled TIME DEADLINE BASED OPERATING SYSTEM, filed on even date herewith, and the entire disclosure of which is hereby expressly incorporated by reference.

### BACKGROUND

There are many instances in computer operation where application programs need to exert real-time control. Examples include control systems for aircraft, factories, automobiles, printers, broker transaction computers, etc. A typical implementation would have a dedicated target computer controlling the aircraft, factory, etc., with target application programs on the target computer. The target computer could be uplinked via a TCP-IP ethernet link, serial linked, networked or otherwise connected to a host computer. The host computer could be a Unix®-based workstation or a Windows®-based PC, for example. The host computer can be used to download and configure application programs to run on the target computer, and to customize such application programs as well.

U.S. Pat. No. 5,872,909 entitled “Logic Analyzer for Software,” (“the '909 patent”), describes a system which logs events occurring in target application programs and provides a graphical representation that displays context status information in a time-line fashion. The graphical representation utilizes specific icons indicating events and status changes to show the interaction over time of tasks and interrupts being executed on the target computer in connection with the application programs. The system is useful for monitoring performance of application programs, in particular real-time, embedded or multi-tasking application programs running on a target computer. The WindView®g software analyzer product manufactured and distributed by Wind River Systems, Inc. is a commercially available product that has made use of this system with a host monitoring a separate target.

The system of the '909 patent logs events which occur during execution of application programs executing in the target computer, and stores these in a buffer for periodic uploading to the host system. Such events include context switching times of particular tasks, and task status at such context switch times, along with events triggering such a context switch or other events. The host system reconstructs the real-time status of the target application programs from the limited event data uploaded to it to create the graphical representation. The status information is then displayed in a user-friendly manner. This provides the ability to perform a logic analyzer function on software such as the application programs executing in the target computer, in real time (or as a post-mortem). A display having multiple rows, with one for each task or interrupt level, is provided. Along a time line or an axis representing a sequence of events, an indicator shows the status of each task/interrupt with icons indicating events and any change in status. The task-status may be indicated with different line patterns or stipples, for example, a wavy line indicating that a program is ready to run, a dotted line indicating that a program is waiting for a semaphore or a message from a message queue that it needs to run, and a dashed line indicating the program is waiting for a time-out. This detailed graphical interface provides an easily understood overall representation of the status of a target software.

“Real-time operating systems,” have been developed to provide a more controlled environment for the execution of application programs in an embedded system such as a dedicated target computer. Real-time operating systems are designed to be “deterministic” in their behavior—i.e., responses to events can be expected to occur within a known time of the occurrence of the event, without fail. Determinism is particularly necessary in “mission-critical” and “safety-critical” applications, where the outcome of event responses is essential to proper system function. Real-time operating systems are therefore implemented to execute as efficiently as possible with a minimum of overhead.

Real time operating systems include the time deadline based operating system disclosed in the co-pending application referred to above. In the time deadline based operating system, a plurality of processes are each started based on a timer, with each process starting execution according to a start time specified in a time table. If one of the processes starts execution while another previously started process is executing, the process already executing is preempted. Moreover, based on a timer, an executing processes is stopped regardless of whether the process has stopped execution normally, each process stopping execution according to a deadline specified in the time table.

It is very important in real time systems that tasks are executed when expected, especially in an operating system, such as disclosed in the co-pending application, where tasks are executed in a specific order, regardless of task completion or priority. To configure such an operating system, post-mortem analysis would repeatedly be necessary as different start time and deadline schemes are attempted on a trial and error basis. Then, for example, during operation of the system, the results of the operation can be checked, and the various start times and deadlines can be changed to improve the functioning of the computing environment. In an example of the time deadline operating system of the co-pending application, the time table is stored in a read/write storage device (e.g., RAM) of the target computer. In this manner, the table can be accessed and modified. The time table would then have to be manually updated with each trial run until the optimal configuration is found.

### SUMMARY OF THE INVENTION

According to one exemplary embodiment of the present invention, a method for configuring an operating system is provided. The method includes the step of creating a task schedule on a host, the schedule comprising tasks, task start times, and task deadlines. The task schedule is used to configure a time deadline based operating system on a target computer according to the task schedule. The target operating system is run, while simultaneously capturing event data. The event data is converted into a corresponding graphical representation indicative of the occurrence of significant events on the target, the significant events corresponding to the task start times and the deadlines. The method includes the further step of changing the task start times and task deadlines in response to user interaction with reference to the graphical representation, the changes corresponding to specific significant events; and using the changes to adjust and recreate the task schedule.

According to another exemplary embodiment of the present invention, a computer system is provided. The computer system comprises a host computer and a target computer coupled to the host computer. A time deadline based operating system is configured on the target computer, and the target computer is operated to execute the time deadline based operating system, while capturing event data and uploading the event data to the host computer via the coupling. The host computer operates to convert the event data into a corresponding graphical representation and the host computer further operates to reconfigure the time deadline based operating system via the coupling with the target computer, in response to user interaction with reference to the graphical representation.

### BRIEF DESCRIPTION OF THE DRAWINGS

FIG. 1 is a diagram of a target and a host computer according to an embodiment of the present invention.

FIG. 2 is a diagram of a graphical representation according to an embodiment of the present invention.

FIG. 3 shows first, second, and third time triggered tasks, according to the present invention.

FIGS. 4A and 4B show exemplary time tables used to control execution of time triggered tasks according to the present inventions.

FIG. 5 shows a conceptual diagram of a task.

FIG. 6 shows a conceptual diagram of a task placed in different states.

FIG. 7 shows an exemplary use of the states of FIG. 6 as applied to the present invention.

FIG. 8A is a display graphic according to an embodiment of the present invention.

FIG. 8B is a modified version of the display of FIG. 8A.

FIG. 9 is a timing diagram of tasks and hook routines according to an embodiment of the present invention.

FIG. 10 is a flowchart of host processes according to an embodiment of the present invention.

FIG. 11 is a flowchart of target processes according to an embodiment of the present invention.

### DETAILED DESCRIPTION OF THE PREFERRED EMBODIMENTS

In accordance with one embodiment of the present invention, an operating system configuration tool is provided using a software logic analyzer, for example the WindView® software logic analyzer product manufactured and distributed by Wind River Systems, Inc., to graphically configure a time triggered operating system by using the logic analyzer to calibrate time-triggered tasks to develop a time schedule for the tasks.

A task schedule is created on a host computer by entering values into a table or by drawing a time graph. A corresponding configuration table is generated in an operating system configuration language or programming language, the operating system is configured, and the resulting configuration downloaded to a target computer and run. As the target runs, its running task schedule is captured and compared with the created task schedule. Any changes necessary to accommodate worst case execution times (WCET) can be made and the resulting, updated configuration table downloaded to the target creating a feed-back loop from the system to the user.

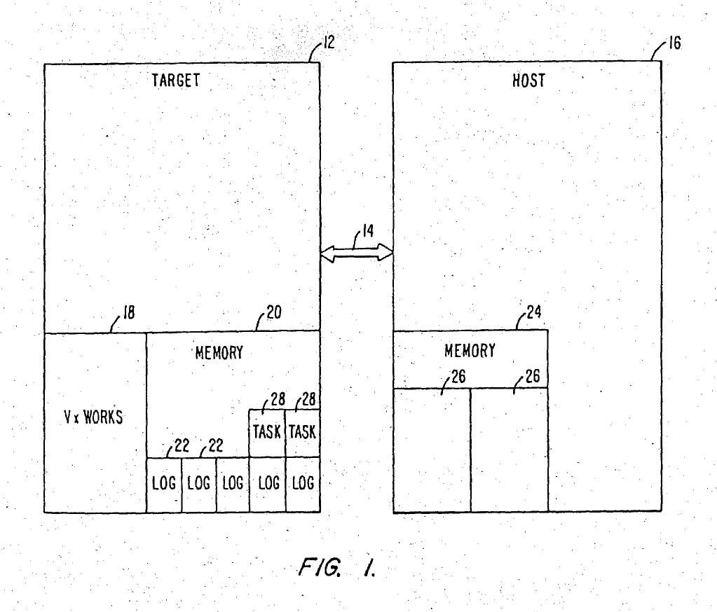

FIG. 1 illustrates a target computer 12 connected via a link 14 to a host computer 16. The target computer includes an operating system (OS) 18, and a memory 20 with a buffer for storing logs of events 22, which are periodically uploaded to host 16 via link 14. Host 16 includes a memory 24 with reconstructed data fields 26. Data fields 26 are reconstructed from the event logs 22 to provide the status of different tasks running in the operating system 18. These different tasks are stored in memory 20, indicated as tasks 28, and run as needed.

Link 14 is preferably an ethernet link, using TCP-IP protocol. Alternately, link 14 can be a connection over an in-circuit or ROM emulator, a serial line or any other point-to-point communication means known. Host 16 is typically a workstation running a Unix® or Unix® based operating system, or a PC running Windows operating system.

The significant events 22 which are logged include switching from one task 28 to another, a change in the state of a task, or certain events which the user desires to display on a debug display. When logged, the events are time-stamped. Target computer 12 could be a separate traditional stand-alone computer, or could be an embedded computer board that is designed to be plugged into a car, printer, etc.

In addition to the target-and-host structure set forth above, aspects of the present invention are useful where a single computer runs both the target and host software. An example is a multi-tasking environment running on a workstation with significant power and memory. The uploading bandwidth is not a constraint in this environment, but the lack of intrusiveness and the ability to provide the status and event display are very useful.

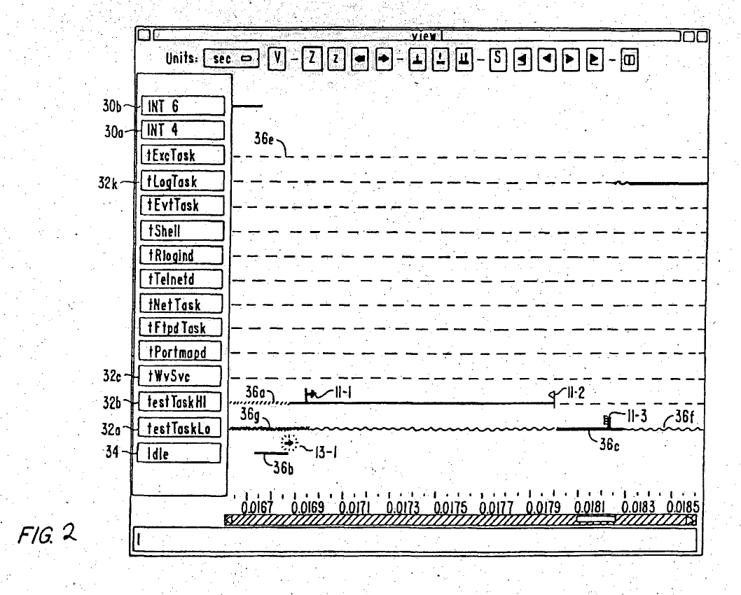

FIG. 2 shows an example of the main display used by the present invention. The information collected in the logs is represented graphically to show the states of a number of tasks within the system being monitored. Along a vertical axis are indicated tasks or interrupt service routines (ISRs), such as tasks 32 and ISRs 30. The horizontal axis is a time line, with information displayed along the time line for each program. The display indicates the state of each task 32 at a particular time and the execution of a particular ISR.

FIG. 2 also shows a representation of an “idle loop” 34. Not actually a task or an ISR, the idle loop is the code which the operating system kernel executes when there are no tasks ready to execute and no interrupts to service. In this loop, the kernel typically services interrupts as they arise and continually checks to see if any task is ready to run. A representation of the idle loop along with the tasks and ISRs is useful in that analyzing the amount of time a system is idle can help the user fine tune the application(s). Too much time in the idle loop may mean the application(s) is not using the CPU efficiently. Too little time may mean that the application is interrupted too often to run efficiently.

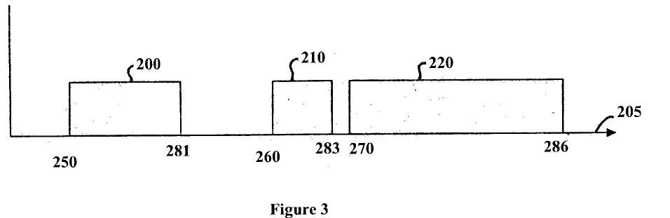

FIG. 3 shows a time line illustrating a simple example of first, second, and third time triggered tasks 200, 210, 220 to be executed by the target computer 12 of FIG. 1, according to a time deadline based operating system utilized in an exemplary embodiment of the present invention. The x axis 205 represents the progression of time. At a first start time point 250, the first time triggered task 200 starts execution. At or before the first time point 250 a timer (e.g., a variable) is set to expire at a first expiration time or deadline 281 for the first time triggered task 200. To determine when the timer expires, the timer is compared to the amount of system clock ticks that have occurred. At the first deadline 281, the first time triggered task 200 stops execution regardless of whether the first time triggered task 200 has completed execution or not. Also, in this example, when the first expiration time 281 occurs, the timer is set for a second start time point 260. When the timer expires at the second start time point 260, the second time triggered task 210 starts execution, and the timer is set to expire at a second expiration time or deadline 283 for the second time triggered task 210. When the second deadline 283 occurs, the second time triggered task 210 stops execution regardless of whether the second time triggered task 210 has completed execution or not. Also, when the second expiration time 283 occurs, the timer is set for a third start time point 270. When the timer expires, the third time triggered task 220 starts execution, and the timer is set to expire at a third expiration time or deadline 286 for the third time triggered task 220. When the third deadline 286 occurs, the third time triggered task 220 stops execution regardless of whether the third time triggered tasks 220 has completed execution or not.

The first, second, and third time points 250, 260, 270 are determined at design time and are stored in the time table. The first, second, and third expiration times or deadlines 281, 283, 286 are also determined at design time and are stored in the time table. In one example, the expiration times 281, 283, 286 could be scheduled at 10 ms, 20 ms, and 30 ms, respectively.

In certain embodiments according to the present invention, more than one timer can be used. For example, a separate timer could be used for each start time and each expiration time (deadline). Also, in a certain embodiment of the present invention, a timer can be set for the first point in time 250 before the first task 200 starts execution. Then, when the timer expires, the first task 200 begins execution.

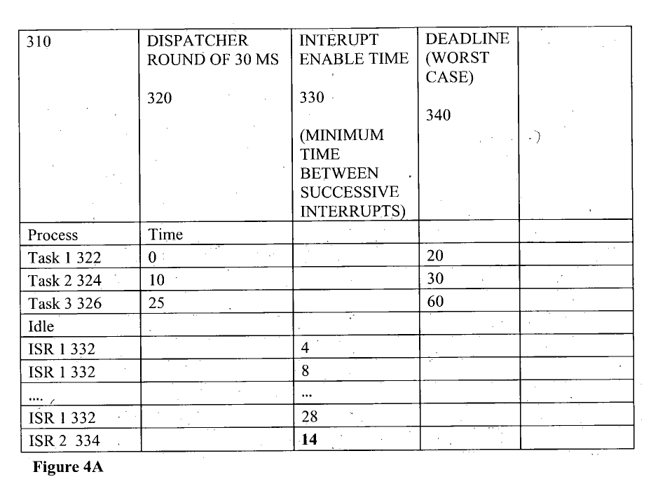

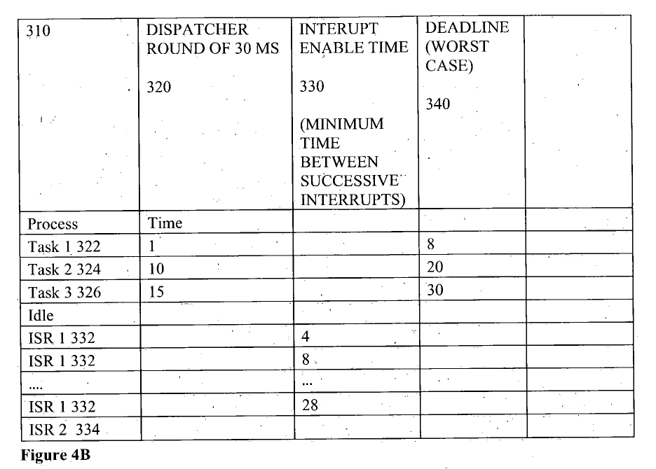

FIG. 4A shows an exemplary time table 300. Preferably, the time table is created when the operating system is configured. The table includes a first column 310 that shows a list of processes that can include tasks and/or ISRs. In the present example, first, second, and third tasks 322, 324, 326 are shown. Also shown in the present example are first and second ISR's 332, 334. The time table shown in FIG. 3A allows for disablement and re-enablement of ISRs (explained below). A second column 320 determines at what time each of the first, second, and third tasks 322, 324, 326 start execution. If a particular task has not finished execution at a time when a subsequent task is scheduled to start, the particular task is placed in a preempted state (e.g., pushed to a stack) and the subsequent task begins execution. For example, the first, second, and third tasks 322, 324, 326 can be set to start execution at 0 ms, 10 ms, and 25 ms, respectively. A third column 330 determines at what time the first and second ISRs 332,334 are re-enabled. For example, the first ISR 332 can be re-enabled at 4 ms, 8 ms, and 28 ms. A fourth column 340 determines a deadline for the first, second, and third tasks 322,324,326. The deadline is used to specify the maximum amount of time a task can execute before execution of the task is stopped. If the deadline is reached before the task has finished execution, the operating system or user can be informed by a message (e.g., an error message). Note that the deadlines can be set at times after a subsequent task is scheduled to start. This is because a task can start, be interrupted by a subsequent task, resume, and then finish execution before the deadline occurs. In the example of FIG. 4A, the first, second, and third tasks 322, 324, 326 have deadlines of 20 ms, 30 ms, and 60 ms, respectively. The deadlines, start execution times, and ISR re-enable times are used when setting the timer(s).

The tasks and ISRs can also be assigned priority levels. The priority levels specify which process (e.g., a task or ISR) can preempt another process. Preferably, in this example of the present invention, all the tasks are assigned the same priority level, so that one task can not synchronously preempt another task. However, the interrupts can have different priority levels. For example, the highest priority level interrupt could be a timer ISR. Thus, when the timer expires, the timer ISR can interrupt a currently executing task or ISR and perform an action (e.g., push the currently executing task to a stack, and start execution of a next scheduled task, according to the time table). Other interrupts could have different levels.

Table 1 shows priority levels assigned to the tasks 322, 324, 326 and ISRs 332, 334 shown in FIG. 4A. In Table 1 the interrupts, as well as the tasks have priority levels. Preferably, the tasks all have the same priority level. If an interrupt has a higher priority level than a task, the interrupt can interrupt (e.g., preempt) the task. Likewise, if an interrupt has a higher priority level than another interrupt, the interrupt with the higher priority level can interrupt the interrupt with the lower priority level. For example, when an interrupt with a higher priority level than a currently executing process (e.g., a task or interrupt with a lower level) occurs, the current procedure is preempted (e.g., placed on a stack.) The interrupt then executes. When the interrupt finishes, the preempted procedure is removed from the stack and resumed. In certain embodiments according to the present invention, except for the idle task, no priorities are used for tasks. In such an embodiment, all the tasks are equal with regard to the operating system, and no task may interrupt another task.

TABLE 1

| Process | Level |
|---|---|
| Timer ISR | 1 |
| ISR 1 | 2 |
| ISR 2 | 2 |
| TASKS | 3 |
| Idle | 4 |

In Table 1 note that the highest priority level is indicated by the numeral 1, and the lowest priority level is indicated by the numeral 4. The Timer ISR has the highest priority level, thus it always has priority over any other ISRs or tasks. Also note that the Idle task has the lowest priority level, thus, any of the other tasks or ISRs can preempt the Idle task.

In the example given in FIG. 4A, a first task 322 starts at time 0. If the first task 322 does not finish by 10 ms, then at 10 ms the timer ISR causes the first task 322 to be preempted by a second task 324. This is because the second task 324 has a start time set in the table 300 at 10 ms. The first task 322 would be placed in a preempted state (e.g., pushed to a stack). Likewise, if the second task 324 does not finish by the 25 ms start time selected for a third task 326, then at 25 ms the second task 324 is preempted by the third task 326. If the second task finishes before 20 ms (the deadline set for the first task 322), the first task 322 can resume execution (e.g., is popped from the stack). However, if the first task 322 does not finish execution by 20 ms (the selected deadline time for the first task 322), execution of the first task 322 is ended by the operating system (e.g., the task is terminated). Likewise, if the third task 326 finishes execution before the 30 ms deadline for the second task 324 (as set in the table 300), the second task 324 can resume execution (i.e., is popped from the stack). However, if the second task 324 does not finish by 30 ms, execution of the third task 326 is ended by the operating system (e.g., the task is terminated). Of course, in this example, if the third task 326 does not complete execution by the 60 ms deadline set for the third task 326 in the table 300, execution of the third task 326 is ended by the operating system.

If the first ISR 332 occurs while any of the tasks are executing, the tasks are interrupted by the ISR 332 and could be placed in the preempted state. This is because the first ISR 332 has a higher priority level (e.g., 2) than the tasks (e.g., 4). When the first ISR 332 finishes execution, the previously executing task is popped from the stack and resumes execution (e.g., placed back in the running state). Note that if the deadline 340 for the task has passed due to the execution time of the first ISR 332, execution of the task is ended by the operating system.

In certain embodiments of the present invention, after the ISR finishes execution, a check could be made to determine if the deadline for a particular task has passed before resuming execution of the task. In such an embodiment, execution of the task could be stopped before resuming the task (e.g., the task is directly placed into the terminated state). After the first ISR 332 has executed, a semaphore or similar programing construct is set to prevent the first ISR 332 from executing until the interrupt enable time (e.g., time interval) listed in the third column occurs. When the interrupt enable time occurs (e.g., the timer reaches the specified time interval) the programing construct can be reset. For example, if the first ISR 332 executes at 2 ms, the first ISR 332 is prevented from executing again until the timer reaches 4 ms.

FIG. 4B is a table similar to FIG. 4A, except that some of the timer events are changed to provide a further example of the operation of the exemplary time deadline based operating system. The first, second, and third tasks 322,324,326 start execution at 1 ms, 10 ms, and 15 ms, respectively. Moreover, the deadlines for the first, second, and third tasks 322, 324, 326 are 8 ms, 20 ms, and 30 ms, respectively.

In the example given in FIG. 4B, the first task 332 begins execution at 1 ms. If the first task 322 does not finish by the 8 ms deadline set in the table for the first task 322, then at 8 ms the execution of the first task 322 is stopped (i.e., placed in the terminated state). The second task 324 begins at 10 ms (e.g, placed in the running state). If, for example, the first ISR 332 occurs at 13 ms, then the second task 324 is preempted (e.g., placed in the preempted state). The first ISR 332 then executes. If the first ISR 332 finishes execution before 20 ms, the second task 324 is popped off of the stack and resumed (e.g., placed in the running state).

However, if first ISR 332 is still executing at 15 ms (the start time for the third task 326), the timer ISR (which has the highest priority) interrupts the first ISR 332 to place the third task 326 on the stack (e.g., in the preempted state), the first ISR 332 then resumes execution. When the first ISR 332 finishes, the third task 326 is placed in the running state (e.g., popped from the stack). If the third task 326 finishes before 20 ms, the second task 324 is placed in the running state.

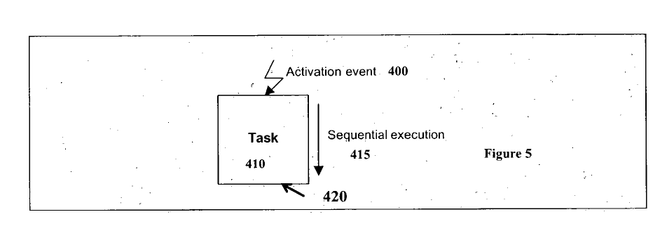

FIG. 5 shows a conceptual diagram of a task 410. An activation event 400 (e.g., expiration of the timer) starts the execution of the task 410. The task 410 then executes 415 until a stop event 420 (e.g., the task finishes execution or the timer expires at a deadline) occurs.

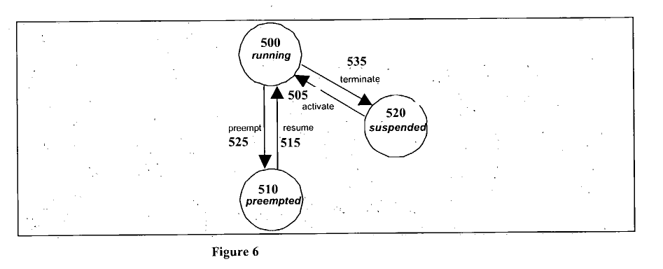

In certain embodiments according to the present invention, a task can be placed into different states. This is shown in FIG. 6. For example, a task can be in a running state 500, preempted state 510, or suspended state 520. In the running state 500, the processor is assigned to the task, so that the task can be executed. The running state 500 occurs, for example, when the task is executing. The suspended state 520 occurs when a task is passive, but can still be activated. In the suspended state 520, the task is not executing. For example, a task can enter the suspended state 520 when the deadline for the task has been reached. The suspended state 520 could also be the default state of any tasks that have not yet started execution. In the preempted state 510, the instructions of the task are not executing. The preempted state 510, for example, can be entered from the running state 500 by a currently executing task when another task changes from a suspended state 520 to the running state 500 upon the occurrence of the start time for the other task. Moreover, the preempted state 510 can occur when an ISR interrupts a currently executing task. In the preempted state 510, the data pertaining to the task could be stored by pushing the data onto a stack. When the task moves from the preempted state 510 to the running state 500, the data pertaining to the task could be popped from the stack.

State changes, which can be sent by, e.g., the scheduling process of a timer ISR, or caused by expiration of the timer(s), can cause states to change from the running state 500, preempted state 510, or suspended state 520 to one of the other states. For example, an activate change 505 moves a task from the suspended state 520 to the running state 500. A resume 515 change moves a task from the preempted state 510 to the running state 500. Preferably, the last task to enter the preempted state 510 is the task that is moved to the running state 500. A preempt change 525 moves the task in the running state 500 to a preempted state 510. The preempt change could occur, for example, if another task start time occurs or an ISR preempts the current process. A terminate change 535 moves a task from the running state 500 to the suspended state 520.

In certain embodiments according to the present invention, when the timer expires, a scheduler, such as a timer ISR, could move the tasks from one state to another. For example, an activate change could be issued when a task is scheduled to start. A resume change could be issued when a task that has been preempted by the scheduler or by an ISR with a higher priority level, is moved back to the running state. A preempt change could be issued when the scheduler starts execution of a new task or when an ISR of a higher priority is activated. A terminate change could be issued when a task has completed execution. In certain embodiments according to the present invention, the task could issue the change instead of the scheduler. The scheduler can then place the task in the appropriate state. For example, on completion a task could issue a terminate command to the scheduler. Also, in certain embodiments of the present invention, the task could place itself in a particular state. For example, the timer could be implemented as a semaphore for each task. When the semaphore associated with the task reaches a deadline time, the task could terminate itself. In certain embodiments according to the present invention, a semaphore associated with each task could issue commands to change states. For example, the semaphore could place a task in a state and issue a message to the scheduler.

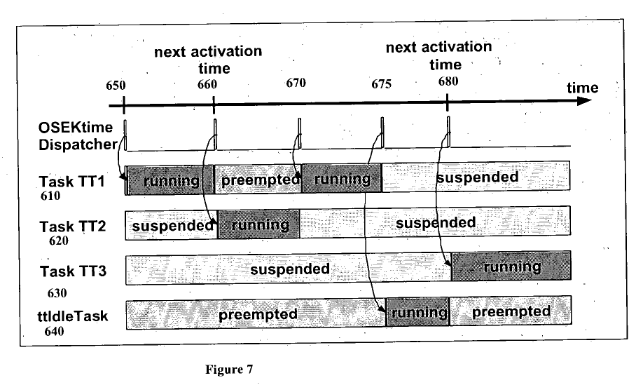

FIG. 7 shows an exemplary use of the states of FIG. 6 as applied to the present invention. Shown is the time triggered scheduling for first, second, third tasks and an idle task 610, 620, 630, 640. At a first time 650, the first task 610 is in the running state 500 and the second task 620 is in the suspended state 520. A third task 630 is also in the suspended state 520, and the idle task 640 is in the preempted state 510. The first time 650 could, for example, occur after the first task 610 has been scheduled and the idle task 640 has been preempted. At a first activation time 660 (e.g., the timer expires for a start time of the second task), the second task 620 enters the running state 500 and the first task 610 is moved to the preempted state 510. At a first stop time 670 (e.g., the second task finishes execution), the second task finishes executing and returns to the suspended state 520, and the first task 610 resumes the running state 500. At a second stop time 675 (e.g., the timer expires for the deadline time of the first task), the first task is moved to the suspended state 520, and the idle task 640 enters the running state 500. At a second activation time 680 (e.g., the timer expires for a start time of the third task), the third task 630 enters the running state 500, and the idle task 610 switches to the preempted state 510. In certain embodiments according to the present invention, if a task does not finish by the deadline, the operating system signals the relevant application via a procedure call and the system is reset.

As noted above, with the time triggered approach utilized in the present invention, a complete task and ISR (Interrupt Service Request) time table is determined when the operating system is designed. The time table is stored in the target computer 12. Based on the operating system design, each task is started at a preselected, definite start time. Likewise, tasks stop executing at a particular time (e.g., a deadline time) although the tasks may stop before the deadline time if execution is completed. With regard to ISRs, an enable time is used to prevent an ISR from executing more than once until a known amount of time has elapsed. For example, the operating system can disable the ISR once it executes, and then enable the ISR once again when the specified enable time has elapsed (e.g., by use of a binary semaphore). Examples of time tables are shown in FIGS. 4A & 4B. Preferably, the tasks and ISRs are scheduled with a precision of 1 microsecond.

To configure the Operating system, a set of tasks and the time it takes to complete each task are determined from the timing characteristics (offsets, worst case execution times, and deadlines) of each task, in the order they should occur in the operation of a particular system. Tasks can be scheduled at the microsecond, rather than millisecond level. From the timing characteristics, a user creates a table that serves as the task schedule, like that in Table 2. The dispatcher of the operating system activates the tasks in a strict sequential order in accordance with the table. All tasks should be completed by the end of the dispatcher round. To start the round, a global time impulse may be used to indicate the beginning of the time table.

The first column of Table 2 lists the tasks and their corresponding activate and deadline check ISRs in sequential order of execution. The second column lists the start times for each task ISR. If a particular task has not finished execution at the time a subsequent task is scheduled to start, the task is placed in a preempted state (e.g., pushed to a stack) and the subsequent task begins execution. The third column contains deadlines for Task 1, Task 2 and Task 3 which specify the maximum amount of time a task can execute before an error is issued. Assuming it is known that an ISR takes 2 ms to execute, each task can be set to run for its allotted time minus an amount of time sufficient for a corresponding ISR to execute, in this example, minus 2 ms.

The first, second, and third tasks can, by way of example, have start times of 0 ms, 15 ms, and 30 ms, respectively, and corresponding deadlines of 20 ms, 35 ms, and 50 ms, respectively. From 0 to 13 ms, Task 1 will run. At 13 ms, an activate ISR is executed to place Task 1 in a preempted state (in the event Task 1 is still executing), and activate Task 2. Because the activate ISR takes 2 ms to complete, Task 2 will start at 15 ms, the scheduled start time for Task 2.

At 20 ms, the scheduled deadline for Task 1, a Deadline check ISR for Task 1 is activated to determine whether Task 1 has completed execution. If Task 1 is still executing, there is a deadline violation, and appropriate action, for example, the sending of an error message, is taken by the Deadline check ISR. At 28 ms, an Activate Task 3 ISR is executed, so that it can activate Task 3 by the 30 ms start time for Task 3. As shown in Table 2, Deadline check ISR's are executed at each of 35 ms and 50 ms, respectively to determine whether each of Task 2 and task 3 completed execution before their respective scheduled deadlines.

TABLE 2
Task schedule.

| Process | Time | Deadline |
|---|---|---|
| Task 1 | 0 | 20 |
| ISR Activate Task 2 | 13 | |
| Task 2 | 15 | 35 |
| ISR Deadline check Task 1 | 20 | |
| ISR Activate Task 3 | 28 | |
| Task 3 | 30 | 50 |
| ISR Deadline check Task 2 | 35 | |
| ISR Deadline check Task 3 | 50 | |

Table 2 may serve as the basis for generating the configuration table for the target operating system. It should be noted that to simplify configuration, ISR times may be calculated automatically and integrated into the task execution time as part of running the task, as in the above described examples relevant to FIGS. 3 and 4A and 4B. Alternatively, ISRs may be considered separately from the execution times of the tasks, as scheduled in Table 2.

Preferably, after the configuration table is created, it is stored on the target in a read/write storage device (e.g., RAM). In certain embodiments of the present invention, two or more tables could be used, for example, an executing table and a idle table. Data can be written to the idle table, and then at the end of a dispatcher round (execution of each task at its specified start time), a pointer could be moved to the currently idle table, thereby, making it the executing table.

The target is run according to the configuration task schedule via the dispatcher activating tasks in strict sequential order according to the schedule. Event information is stored in the log buffer each time an event occurs to capture the running task schedule. Hooks into the target operating system kernel allow instrumentation of the target operating system operation. A hook is a location in the kernel that calls out of the kernel to a kernel module routine—a hook exit routine. So when a significant event occurs on the target, a kernel hook allows the target operating system to break away from the current instruction stream of the task, ISR or idle loop, copy data describing the event into the buffer and then return to running the task, ISR or idle loop it broke away from, as described in the '909 patent.

Significant events are those that cause a change in state of any task, and deadline violations, if any. In addition, the states of each task at the end of the dispatcher round are logged as well. Since all tasks should be completed by the end of a dispatcher round, no task should be in a preempted state.

After a dispatcher round finishes, the logs are uploaded to the host where the information is converted into a graphical display using the time stamp associated with each logged event. A graph is generated with a vertical line for each task and a separate vertical line to represent the progression of time. The state of each task at each periodic time unit during the dispatcher round is plotted on a graph with a specific line pattern indicating the task state at the corresponding time on the graph.

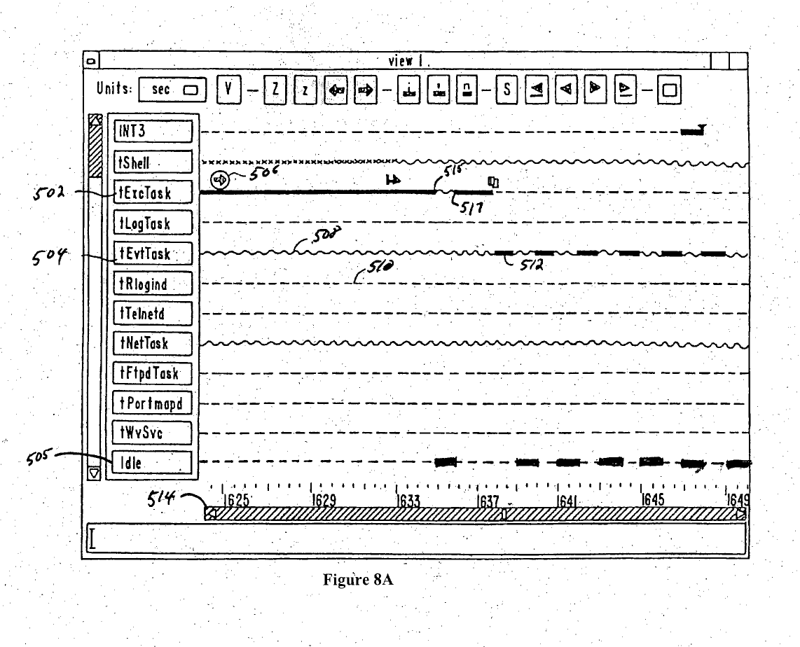

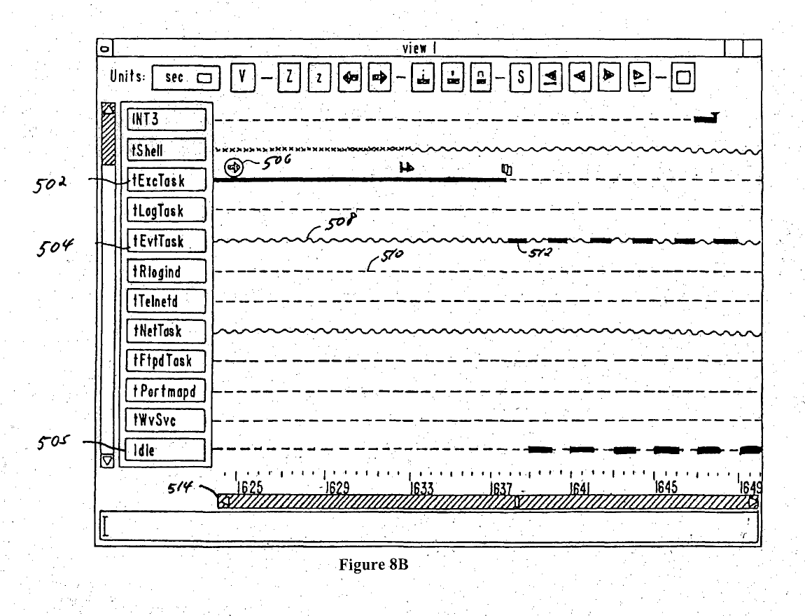

FIG. 8A is an exemplary graphical display of a target log, without separate ISR timing information, according to an embodiment of the present invention. Each task has its own horizontal line to indicate its state at a certain time 514. In this example, ExcTask 502 and EvtTask 504 are the only tasks to execute besides the Idle task 505. A wavy line 508 indicates a suspended state, a dashed line 510 indicates a preempted state, and a thick, solid line 512 indicates the running state. A large arrow icon 506 indicates the start of the dispatcher round.

A corresponding table may be generated as well. Table 3 shows the corresponding task schedule for the graph of FIG. 8A. The values of table 3 and the corresponding points on the graph of FIG. 8A are linked such that a change made to one causes a corresponding change in the other, and vice versa.

TABLE 3

| Process | Time | Deadline |
|---|---|---|
| ExcTask | 1624 | 1635 |
| Idle | 1635 | 1636 |
| ExcTask | 1636 | 1638 |
| EvtTask | 1638 | 1639 |
| Idle | 1639 | 1640 |
| EvtTask | 1640 | 1641 |
| Idle | 1641 | 1642 |
| EvtTask | 1642 | 1643 |
| Idle | 1643 | 1644 |
| EvtTask | 1644 | 1645 |
| Idle | 1645 | 1646 |
| EvtTask | 1646 | 1647 |
| Idle | 1647 | 1648 |
| EvtTask | 1648 | 1649 |
| Idle | 1649 | |

If there is no deadline violation detected, the operating system is configured properly, but may be tweaked for optimal performance according to the user. Changes can be made directly to the display of FIG. 8A or to the original task schedule. For example, to change the graph, a point and click device may be used to drag the termination of ExcTask at time 1635 (point 515) over to time 1636 (point 517). The resulting graph is shown in FIG. 8B. Task ExcTask 502 runs from time 1624 to time 1638 without interruption, and the execution of the Idle task 505 from time 1635 to time 1636 is eliminated. This change could also be done with Table 3 by removing the second and third rows and changing the deadline for ExcTask in the first row to 1638. If changed in the table, the link to the corresponding point on the graph causes the same change in the graph itself. The reverse is also true, if the change is made in the graph, the change is also made in the table via the bi-directional link.

Times between tasks and interrupts may be calculated and used to determine whether the time between tasks (or between tasks and interrupts) exceeds a certain threshold. Run times for tasks and interrupts may be calculated as well with their average, median, max, and min times in a given sampling number (e.g. 100 occurences).

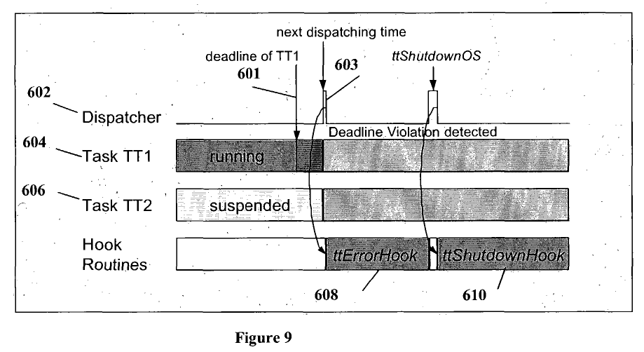

If a deadline violation does occur while the target is running, the system's reaction depends on how it is defined by the user. The operating system may record the violation event in the log, return to the instruction following the violation, and complete the dispatcher round. This may be designed to occur automatically or at the direction of a user command to do so. Alternatively, the dispatcher cycle may be terminated upon violation detection and the log uploaded to the host with notification of the violation. In any event, upon the occurrence of a deadline violation, a hook would be used to take the kernel away from executing the violating task and to record the event in the log. FIG. 9 shows the resulting time graph, assuming the system is configured to shutdown the OS.

For ease of illustration, the example of FIG. 9 assumes there are only two tasks, Task 1 604 and Task 2 606. At time zero, Task 1 604 is running and Task 2 606 is suspended. At the Task 1 deadline 601, the dispatcher 602 detects a deadline violation because Task 1 is still running. At the next dispatching time 603, the dispatcher activates a hook routine, ttErrorHook 608 that stops the operating system from executing any more tasks. Upon completion of ttErrorHook, the dispatcher calls ttShutdownOS 610 to shut the operating system down. The logs are uploaded to the host for analysis to determine the cause of the deadline violation and reconfigure the task schedule visually via the graph or manually via the table.

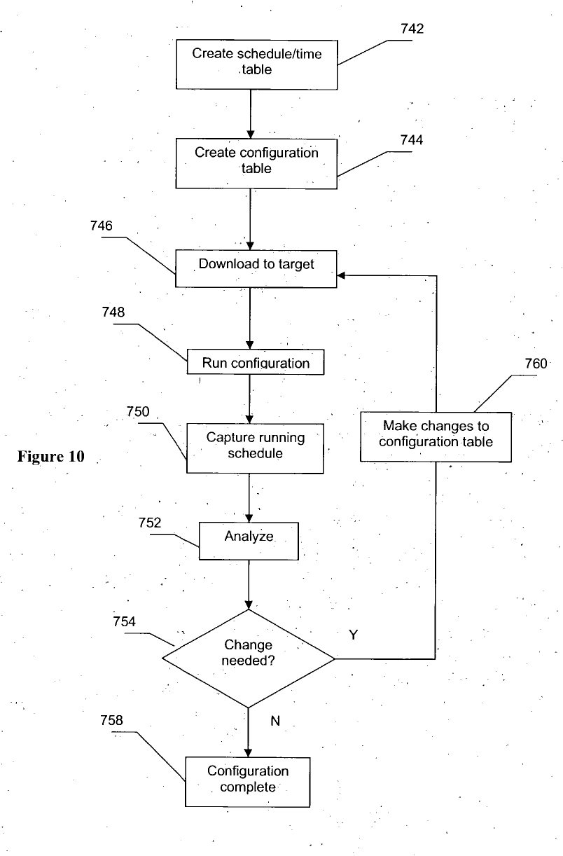

The overall process from the host side is shown in the flowchart of FIG. 10. A user creates a task schedule (step 742). From the task schedule, the configuration tool generates a configuration table (step 744) which is downloaded to the target (step 746). The target is run according to the configuration table (step 748) and the resulting, running schedule is captured (step 750) and analyzed (step 752). In particular, the running schedule is examined for such events as deadline violations. From this analysis, it is determined (step 754) whether changes need to be made to the originally created task schedule. If no changes are necessary, then the configuration is complete (step 758). If, however, changes are necessary, then the appropriate changes are made to the configuration table (step 760) by point and click manipulation in the corresponding graphical representation or by writing in new values (new start time(s) and/or deadline(s)) directly to the table used to configure the operating system. Then the process is repeated (steps 746-754), creating a feed-back loop from the system to the user.

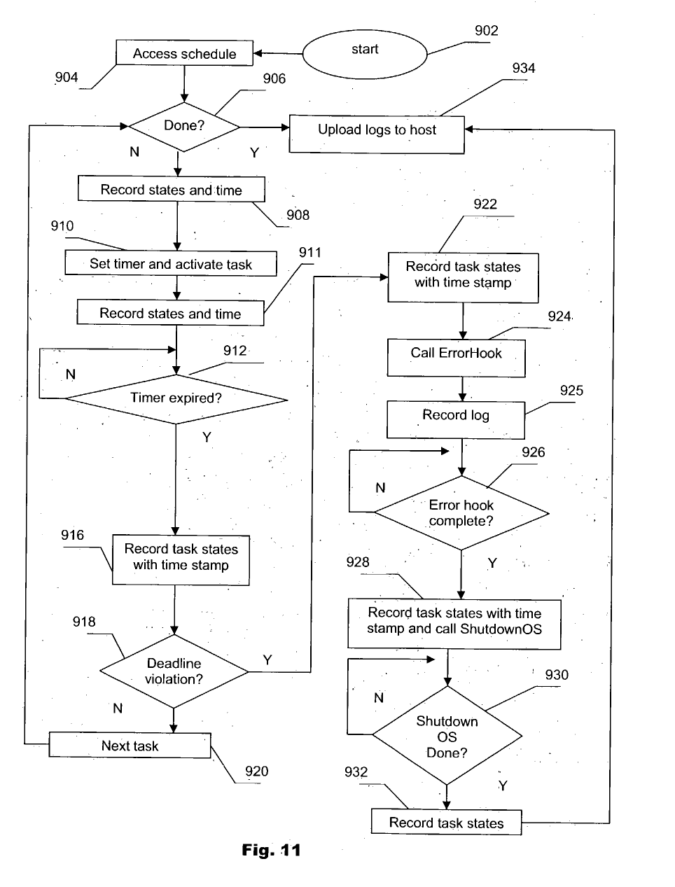

FIG. 11 is a flowchart of the process as it occurs at the target according to an embodiment of the present invention. The target is started (step 902) by some command issued by the host to the dispatcher on the target to execute a round according to the configured task schedule. After executing the start command (step 902), the target dispatcher accesses the task schedule (step 904). The scheduled task is checked to determine whether the round is done (step 906). If the round is not done, indicating there are more tasks to execute in the current dispatcher round (step 906), the target records the states of all tasks with a time stamp (step 908), after which the scheduled task is activated and a timer set for the scheduled time of execution (step 910). After the task is activated (step 910), the states of the tasks are recorded again with their corresponding time stamps (step 911), since there was a change in the state of a task. With each tick of the system clock, the dispatcher determines whether the timer has run out (step 912), which is a significant event that should be logged (step 916). Before moving to the next task in the schedule, the dispatcher checks to see if there is a deadline violation by determining whether the task has terminated in time. This can be done, for example, by a Deadline check ISR, as described above. If there is no deadline violation, the dispatcher moves to the next task (step 920) and determines whether the next task is the end of the schedule (step 906) and therefore, the end of the dispatcher round. If it is not the end of the task schedule, the above process repeats (steps 908-920) recursively until the end of the task schedule and the dispatcher round is reached, assuming no deadline violations occur. When the dispatcher round is done (step 906), the logs are uploaded to the host for analysis and further configuration as discussed earlier (step 934).

If, during the dispatcher round, a deadline violation does occur (step 918), the event is logged (step 922) and, assuming the system is configured as discussed earlier in reference to FIG. 9, ErrorHook is called (step 924) and the task states recorded with a time stamp (step 925). The dispatcher checks the ErrorHook routine at each clock tick to see if the routine has completed (step 926) and when it does, the log is updated with the states of all the tasks and a corresponding time stamp, and ShutdownOS is called (step 928). After ShutdownOS finishes (step 930) the log is again updated (step 932) and uploaded to the host (step 934).

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A method for configuring an operating system comprising the steps of:
creating a task schedule on a host, the schedule comprising tasks, task start times, and task deadlines;
configuring a time deadline based operating system on a target coupled to the host, according to the task schedule;
running the target operating system while simultaneously capturing event data;
uploading the captured event data to the host;
at the host, converting the event data into a corresponding graphical representation indicative of the occurrence of significant events on the target, the significant events corresponding to the task start times and the deadlines;
changing the task start times and task deadlines in response to user interaction with reference to the graphical representation, the changes corresponding to specific significant events; and
using the changes to adjust and recreate the task schedule;
again configuring the time deadline based operating system.

2. The method of claim 1 comprising the further step of storing the task schedule in a table.

3. The method of claim 2 wherein the step of using the changes is carried out by writing at least one of a new task start time and a new task deadline in the table.

4. The method of claim 2 comprising the further step of coupling the table to the graphical representation, and wherein the step of using the changes is carried out by manipulating the graphical representation to change the table.

5. The method of claim 4 wherein the step of manipulating the graphical representation is carried out by a point and click operation.

6. A computer system, comprising:
a host computer;
a target computer coupled to the host computer;
a time deadline based operating system configured on the target computer;
the target computer executing the time deadline based operating system, capturing event data and uploading the event data to the host computer via the coupling;
the host computer operating to convert the event data into a corresponding graphical representation; and
the host computer operating to reconfigure the time deadline based operating system via the coupling with the target computer, in response to user interaction with reference to the graphical representation.

7. The computer system of claim 6, wherein the time deadline based operating system includes a task schedule comprising tasks, task start times and task deadlines, the target computer capturing event data corresponding to the task start times and task deadlines.

8. The computer system of claim 7 wherein the host computer converts the event data corresponding to task start times and task deadlines into a graphical representation.

9. The computer system of claim 8 wherein the task schedule is stored in a table.

10. The computer system of claim 9 wherein the table is coupled to the graphical representation for change of the table via manipulation of the graphical representation.
